(19) United States
(12) Patent Application Publication
(10) Pub. No.: US 2005/0117847 A1
(43) Pub. Date: Jun. 2, 2005

(54) Optical waveguide module

(76) Inventors: Tadashi Ono, Tokyo (JP); Maiko Mishuku, Tokyo (JP)

Correspondence Address: LADAS & PARRY LLP, 224 SOUTH MICHIGAN AVENUE, SUITE 1200, CHICAGO, IL, 60604, US

(21) Appl. No.: 10/929,905

(22) Filed: Aug. 30, 2004

(30) Foreign Application Priority Data
Nov. 27, 2003 (JP) 2003-397469

(51) Int. Cl. G02B 6/30

(52) U.S. Cl. 385/49

(57) ABSTRACT

In an optical waveguide module including an optical fiber array and a high polymer optical waveguide element that are bonded by adhesive, accurate position fixing of the adhesive is realized. The optical fiber array includes a base member having a roughened end surface with an average roughness Ra of 0.2 μm±0.1 μm. The high polymer optical waveguide element includes a substrate having a roughened end surface with an average roughness Ra of 0.2 μm±0.1 μm. A space is created between the roughened end surface of the base member and the roughened end surface of the substrate and the adhesive is placed in this space so that an adhesive part with a desired configuration may be formed.

### BACKGROUND OF THE INVENTION

1. Field of the Invention

The present invention relates generally to an optical waveguide module,. and particularly to an optical waveguide module in which an optical waveguide element and an optical fiber array that is arranged at the end portions of optical fibers are optically and mechanically connected by adhesive.

2. Description of the Relate Art

An optical waveguide module preferably has good optical characteristics so that the optical loss that occurs when light is propagated through the connecting portion of an optical waveguide element and an optical fiber array is limited. Accordingly, it is desired that alignment of the core wires of the optical fibers and the optical waveguides of the optical waveguide element is maintained even after bonding the optical waveguide element and the optical fiber array.

Bonding may be one factor that disrupts the alignment of the core wires of the optical fibers and the optical waveguides of the optical waveguide element. Specifically, adhesive used for the bonding may contract upon hardening, and spreading.: states of the adhesive may differ depending on each case so that differences may occur, for example, in the shapes of the adhesive parts made of hardened adhesive. Thus, the bonding process includes an unstable factor that may affect the alignment of the optical fibers. Further, in the optical waveguide module, the area of the connecting portion between an end surface of the optical waveguide element and an end surface of the optical fiber array is relatively small, and thereby, the differences in the shapes of the adhesive parts, for example, may likely have a large influence on the alignment of the optical fibers.

Accordingly, a prescribed amount of adhesive is preferably arranged to settle at a prescribed position so that the shape of the adhesive part may be close to a desired shape and the bonding state of the optical waveguide element and the optical fiber array may be stabilized. Hereinafter, the act of settling a prescribed amount of adhesive to a prescribed position may be referred to as position fixing.

FIGS. 1 and 2 show an optical waveguide module 1 according to the prior art. As is illustrated in the drawings, the end portions of plural optical fibers 2 are aligned and fixed by an optical fiber array 10. The optical fiber array 10 includes a base member 11 on which upper surface parallel V grooves are formed, and a cover 12. The end portions of core wires 2a of the optical fibers 2 are engaged and positioned to the V grooves 11a formed on the base member 11, and the cover 12 is bonded to the base member 11 by a bonding layer 13 so that the optical fibers 2 may be covered and fixed. A high polymer optical waveguide element 5 includes a substrate 6 on which upper surface a high polymer layer having optical waveguides 7 is formed. An end surface 11b of the base member 11 and an end surface 6a of the substrate 6 both correspond to flat mirror surfaces.

The optical fiber array 10 and the high polymer optical waveguide element 5 are bonded by an adhesive part that is made of hardened adhesive. Specifically, the core wires 2a and the optical waveguides 7 are aligned, and in this state, the end surface 11b of the base member 11 and the end surface 6a of the substrates are arranged to face each other so that the end surface 11b and the end surface 6a are bonded by the adhesive part 20.

Preferably, the adhesive part 20 extends across the area between the end surface 11b and the end surface 6a and includes a portion sticking out along the upper edge, bottom edge, right edge, and left edge of the connecting portion of the end surfaces 11b and 6a. The portion sticking out from the connecting portion is referred to as fillet.

The end surface 11b of the base member 11 and the end surface 6a of the substrates correspond to flat mirror surfaces. Thereby, when the end surface 11b of the base member 11 and the end surface 6a of the substrate 6 are arranged to face each other, it is difficult to create a space between the end surface 11b and the end surface 6a in which the adhesive may be placed. In turn, even when there is a slight deviation in the loading direction of a load that is impinged upon arranging the end surfaces 11b and 6a to face each other, the position fixing of the adhesive may be disrupted and the shape of the adhesive part may be deformed. In other words, in the optical waveguide module of the prior art, it is difficult to realize accurate position fixing of the adhesive.

In the prior art, the shape of the adhesive part can vary significantly depending on circumstances of the bonding process, as is illustrated by FIGS. 3A, 3B, 4A, and 4B. FIGS. 3A and 3B illustrate a case in which the adhesive deviates to the upper side. In this drawing, the adhesive part 20A has a portion 20A1 positioned between the end surface 11b and the end surface 6a that lacks adhesive, and a large fillet 20A2 sticking out from the upper surface side of the high polymer optical waveguide element 5. FIGS. 4A and 4B illustrate a case in which the adhesive deviates to the lower side. In this drawing, the adhesive part B has a portion 20B1 positioned between the end surface 11b and the end surface 6a that lacks adhesive, and a large fillet 20B2 sticking out from the bottom surface side of the high polymer optical waveguide element 5. In the case of FIGS. 3A and 3B, the optical fiber array 10 and the high polymer optical waveguide element 5 tend to warp into a reverse V shape, and in the case of FIGS. 4A and 4B, the optical fiber array 10 and the high polymer optical waveguide element 5 tend to warp into a V shape. It is noted that the adhesive may also deviate to the right side or to the left side. Thus, in assembling optical waveguide modules according to the prior art, a number of the optical waveguide modules assembled may have their alignment states disrupted so as to end up having large optical losses, and thereby, high yield and high reliability cannot be realized in the prior art.

### SUMMARY OF THE INVENTION

The present invention has been conceived in response to the problems of the related art and its object is to provide an optical waveguide module in which accurate position fixing of adhesive may be realized.

The present invention according to one embodiment provides an optical waveguide module including:

an optical waveguide element having a roughened end surface at which end portions of optical waveguides are exposed;

an optical fiber array having a roughened end surface at which end portions of a plurality of core wires of optical fibers are exposed; and

an adhesive part for bonding the optical waveguide element and the optical fiber array that is arranged between the roughened end surface of the optical waveguide element and the roughened end surface of the optical fiber array.

According to one aspect of the present invention, a narrow space may be created between a roughened end surface of an optical waveguide element and a roughened end surface of an optical fiber array that face each other. The space may have predetermined dimensions and be opened to the exterior around the periphery of the connecting portion of the end surfaces. The space may provide a portion in which adhesive may be held in place so that position fixing of the adhesive may be realized. Thereby, an adhesive part having a desired shape may be stably formed.

The present invention according to another embodiment provides an optical waveguide module including:

an optical waveguide element having an end surface at which end portions of optical waveguides are exposed;

an optical fiber array having an end surface from which end portions of a plurality of core wires of optical fibers protrude; and

an adhesive part for bonding the optical waveguide element and the optical fiber array that is arranged between the end surface of the optical waveguide element and the end surface of the optical fiber array.

The present invention according to another embodiment provides an optical waveguide module including:

an optical waveguide element having an end surface at which end portions of optical waveguides are exposed;

an optical fiber array having an end surface at which end portions of a plurality of core wires of optical fibers are exposed, said end surface of the optical fiber array including an end surface of a bonding layer bonding the core wires, which bonding layer end surface is arranged to be recessed with respect to the end portions of the core wires; and

an adhesive part for bonding the optical waveguide element and the optical fiber array that is arranged between the end surface of the optical waveguide element and the end surface of the optical fiber array.

According to an aspect of the present invention, a narrow space may be created between an end surface of an optical waveguide element and an end surface of an optical fiber array. The space may provide a portion in which adhesive may be held in place so that position fixing of the adhesive may be realized. Thereby, an adhesive part having a desired shape may be stably formed.

### BRIEF DESCRIPTION OF THE DRAWINGS

FIG. 1 is a perspective view of an optical waveguide module according to the prior art;

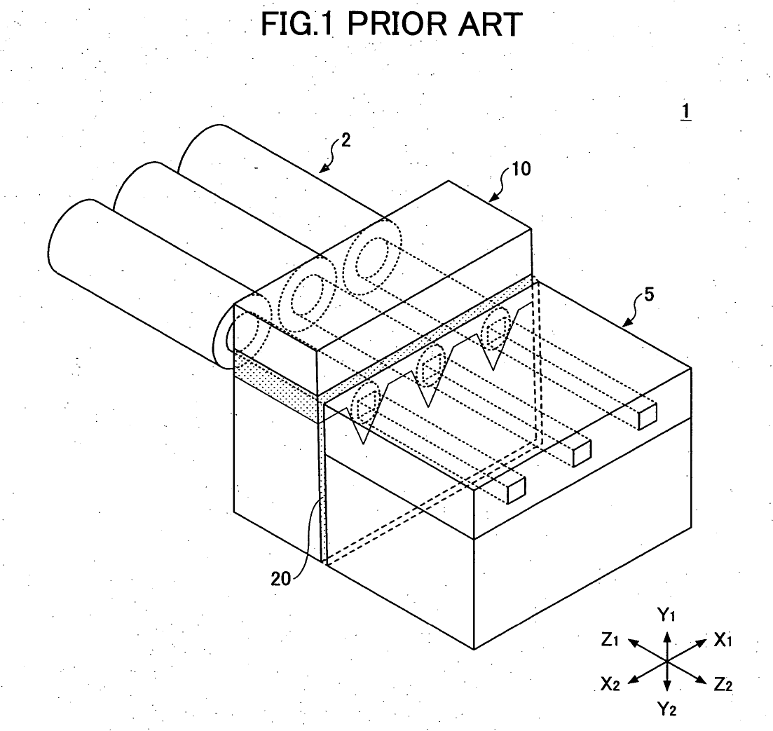

FIG. 2 is a perspective view of a connecting portion between an optical fiber array and a high polymer optical waveguide element of the optical waveguide module shown in FIG. 1;

FIGS. 3A and 3B are diagrams showing an exemplary defect occurring in the optical waveguide module of FIG. 1;

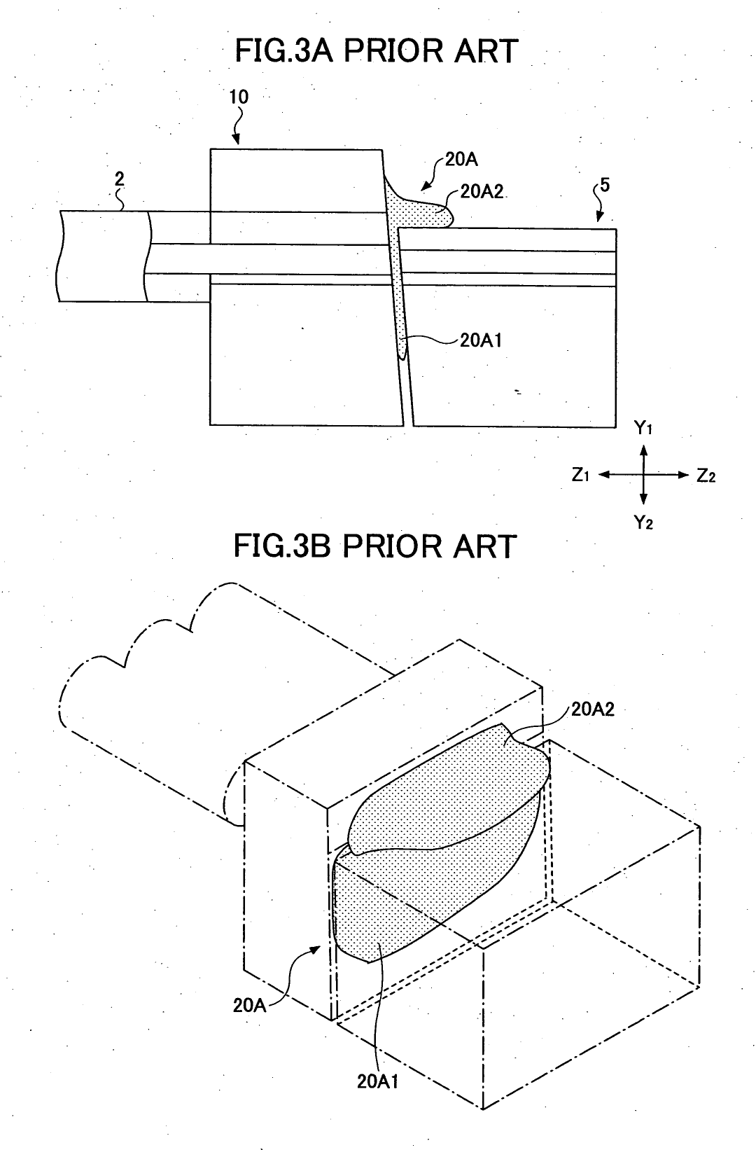

FIGS. 4A and 4B are diagrams showing another exemplary defect occurring in the optical waveguide module of FIG. 1;

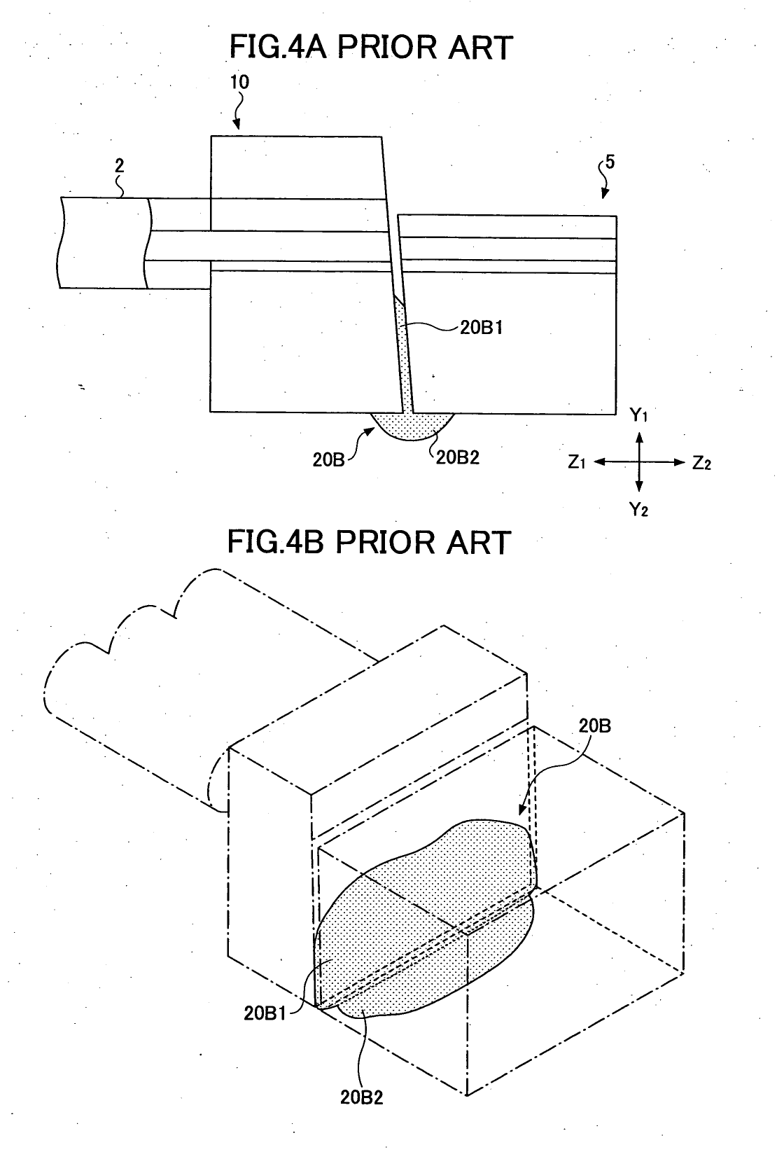

FIG. 5 is a perspective view of an optical waveguide module according to a first embodiment of the present invention;

FIG. 6 is a perspective view of a connecting portion between an optical fiber array and a high polymer optical waveguide element of the optical waveguide module of FIG. 5;

FIG. 7 is cross-sectional elevation view of the optical waveguide module of FIG. 5;

FIG. 8 is a perspective view of an adhesive part of the optical waveguide module of FIG. 5;

FIG. 9 is a perspective view of an optical waveguide module according to a second embodiment of the present invention;

FIGS. 10A and 10B respectively show a connecting portion between an optical fiber array and a high polymer optical waveguide element of the optical waveguide module of FIG. 9, and a surface configuration of the optical fiber array;

FIG. 11 is a cross sectional view of the optical waveguide module of FIG. 9;

FIG. 12 is a perspective view of an adhesive part of the optical waveguide module of FIG. 9;

FIG. 13 is a perspective view of an optical waveguide module according to a third embodiment of the present invention;

FIG. 14 is a perspective view of a connecting portion between an optical fiber array and a high polymer optical waveguide element of the optical waveguide module of FIG. 13;

FIG. 15 is a cross-sectional view of the optical waveguide module of FIG. 13; and

FIG. 16 is a perspective view of an adhesive part of the optical waveguide module of FIG. 13.

### DETAILED DESCRIPTION OF THE PREFERRED EMBODIMENTS

In the following, principles and embodiments of the present invention will be described with reference to the accompanying drawings.

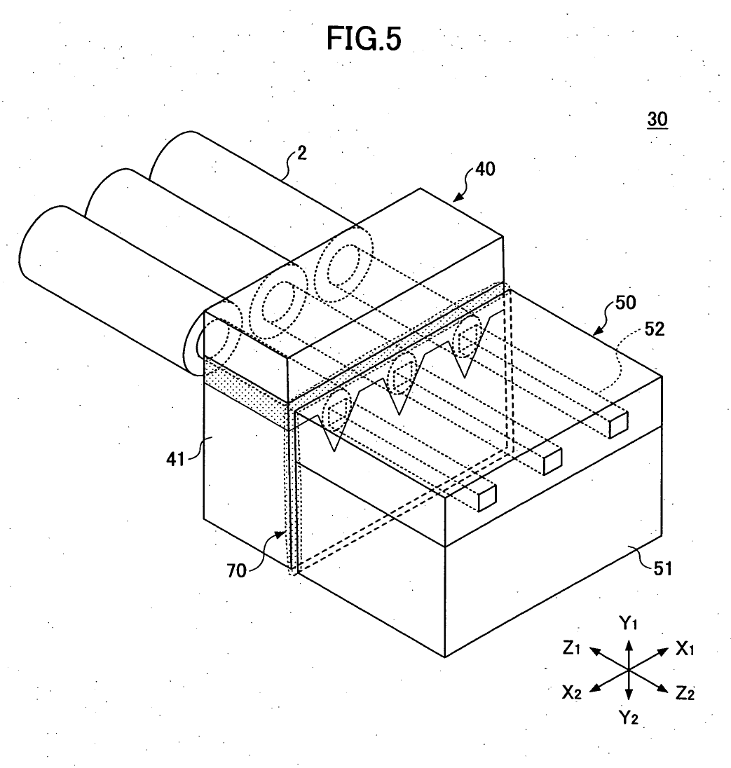

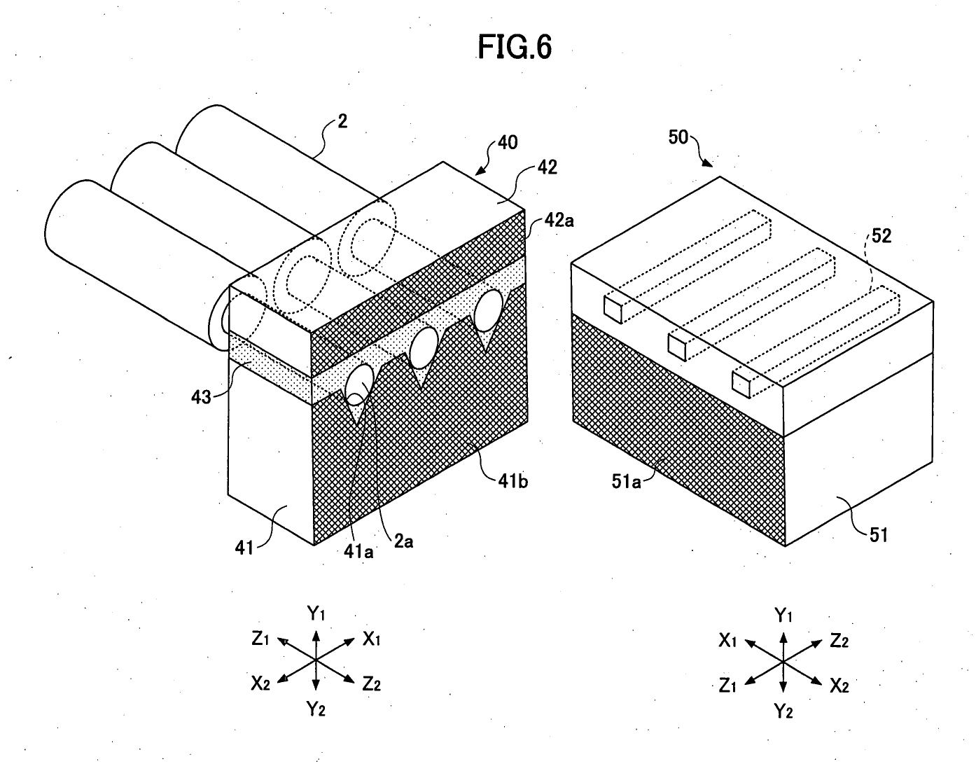

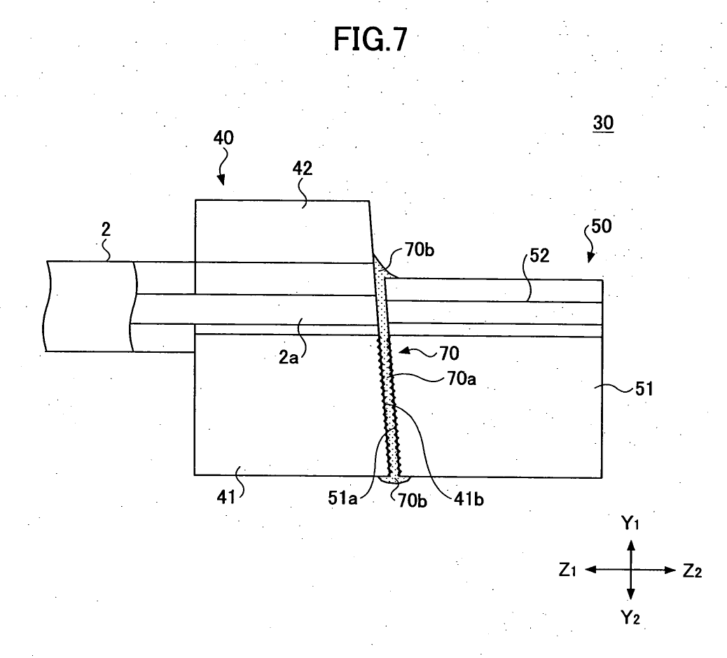

FIGS. 5 through 7 illustrate an optical waveguide module 30 according to a first embodiment of the present invention. FIG. 5 is a perspective view of the optical waveguide module 30; FIG. 7 is a cross-sectional elevation view of the optical waveguide module 30; and FIG. 6 shows the connecting portion between an optical waveguide element and an optical fiber array. In the drawings, directions Z1-Z2 represent length directions, directions X1-X2 represent width directions, and directions Y1-Y2 represent height directions.

The optical waveguide module 30 according to the present embodiment includes an optical fiber array 40 and a high polymer optical waveguide element 50. End portions of plural optical fibers 2 are aligned and fixed by the optical fiber array 40. The optical fiber array 40 includes a base member 41 on which upper surface parallel V grooves 41a are formed, and a cover 42. The ends of core wires 2a corresponding to the end portions of the optical fibers 2 are engaged and positioned to the V grooves 41a formed on the base member 41, and the cover 42 is bonded to the base member 41 by a bonding layer 43 so that the core wires 2a of the optical fibers 2 may be covered and fixed.

The high polymer optical waveguide element 50 includes a substrate 51 on which upper surface a high polymer layer made of resin material and having optical waveguides 52 is formed.

According to the present embodiment, an end surface 41b of the base member 41 of the optical fiber array 40 and an end surface 51a of the substrate 51 of the high polymer optical waveguide element 50 correspond to flat roughened surfaces with an average roughness Ra of 0.2 μm±0.1 μm. An end surface 42a of the cover 42 may also be arranged into a roughened surface. These roughened surfaces may be formed by conducting mechanical processes of lapping and polishing, for example. Alternatively, instead of conducting the mechanical processes, the rough surfaces may be formed by conducting a dry etching process such as ion milling, or plasma etching, for example. Also, the roughened surfaces may be formed by conducting a chemical wet etching process using NF or NH4F, for example.

The optical fiber array 40 and the high polymer optical waveguide element 50 are bonded by an adhesive part 70. Specifically, the core wires 2a and the optical waveguides 52 are aligned, and in this state, the end surface 41b of the base member 41 and the end surface 51a of the substrate 51 are arranged to face each other so that the end surface 41b and the end surface 51b may be connected and fixed by the adhesive part 70. In one embodiment, ultraviolet cure adhesive with a relatively low viscosity of approximately 30 cp may be used for the adhesive part 70, and this adhesive in its hardened state may have optical transparency, a predetermined refraction index, and a predetermined Young's modulus.

According to the present embodiment, the end surface 41b and the end surface 51a correspond to roughened surfaces, and thereby, convex portions of the end surface 41b and the end surface 51a may be faced with each other and concave portions of the end surface 41b and the end surface 51a may be faced opposite to each other. A narrow space (gap) may be formed in the connecting portion between the end surface 41b and the end surface 51a that are facing each other. This narrow space may be opened to the exterior along the upper side, bottom side, right side, and left side of the end surfaces 41b and 51a facing each other. From the interior-portion of the connecting portion between the end surfaces 41b and 51a, plural paths leading to the exterior periphery of the end surfaces 41b and 51a may be formed.

When a loading direction of a load impinged upon arranging the end surfaces 41b and 51a to face each other corresponds to a desired direction, accurate position fixing of the adhesive may be realized. However, according to the present embodiment, even when the loading direction of the load impinged upon arranging the end surfaces 41b and 51a to face each other deviates from the desired direction, the adhesive may penetrate through and spread across the connecting portion between the end surfaces 41b and 51a owing to the capillary effect, and surplus adhesive may stick out evenly around the periphery of the end surfaces 41b and 51a. In this embodiment, the narrow space between the end surfaces 41b and 51a may enable position fixing of the adhesive, and the adhesive may be hardened in this state to be formed into the adhesive part 70. It is noted that, through testing, the inventors of the present invention have discovered that the capillary effect may occur in the adhesive when the average roughness Ra of the end surfaces 41b and 51a is 0.1 μm or greater.

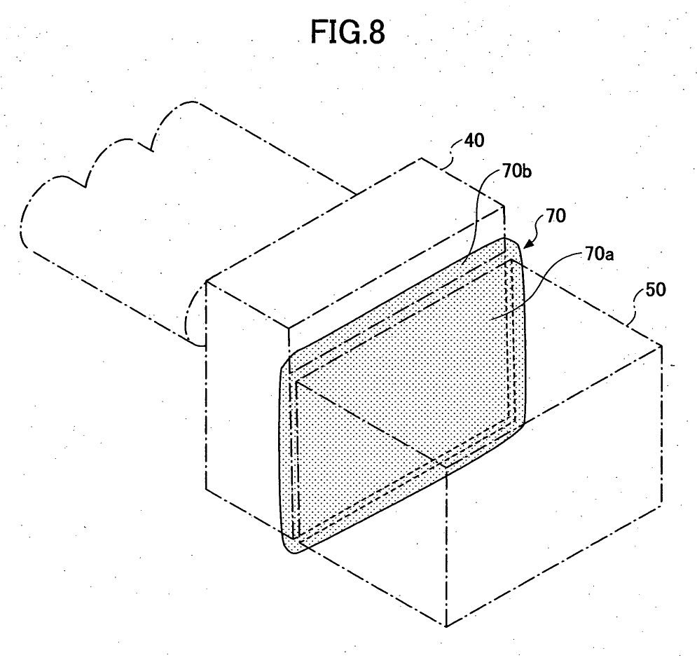

The adhesive part 70 may be arranged to have a configuration as is illustrated in FIG. 8, for example. As is shown in FIG. 8, the adhesive part 70 includes a layer portion 70a that extends across the connecting portion between the end surfaces 41b and 51a, and a fillet 70b that evenly surrounds the periphery of the end surfaces 41b and 51a.

According to the present embodiment, layer portion 70a extends across the connecting portion between the end surfaces 41b and 51a, and thereby, the optical fiber array 40 and the high polymer optical waveguide element 50 may be bonded with sufficient strength. Further; the end surface 41b and the end surface 51a correspond to roughened surfaces, and thereby, the area of the connecting portion at which the layer portion 70a connects the end surfaces 41b and 51a may be increased compared to the case in which the end surfaces correspond to mirror surfaces, and the so-called anchor effect may occur so that the bonding may be further strengthened.

The fillet 70b may be evenly arranged around the periphery of the end surfaces 41b and 51a, including the upper side, the bottom side, the right side and left side of the end surfaces. In turn, a contraction force generated by this fillet 70b along the periphery of the end surfaces 41b and 51a may be uniformly distributed so that the force may not act in a direction that can cause the optical fiber array 40 and the high polymer optical waveguide element 50 to warp into a V shape, for example, to disrupt the alignment of the core wires 2a of the optical fibers 2 and the optical waveguides 52 of the optical waveguide element 50. In this way, the alignment of the optical fiber array 40 and the high polymer optical waveguide element 50 may be maintained.

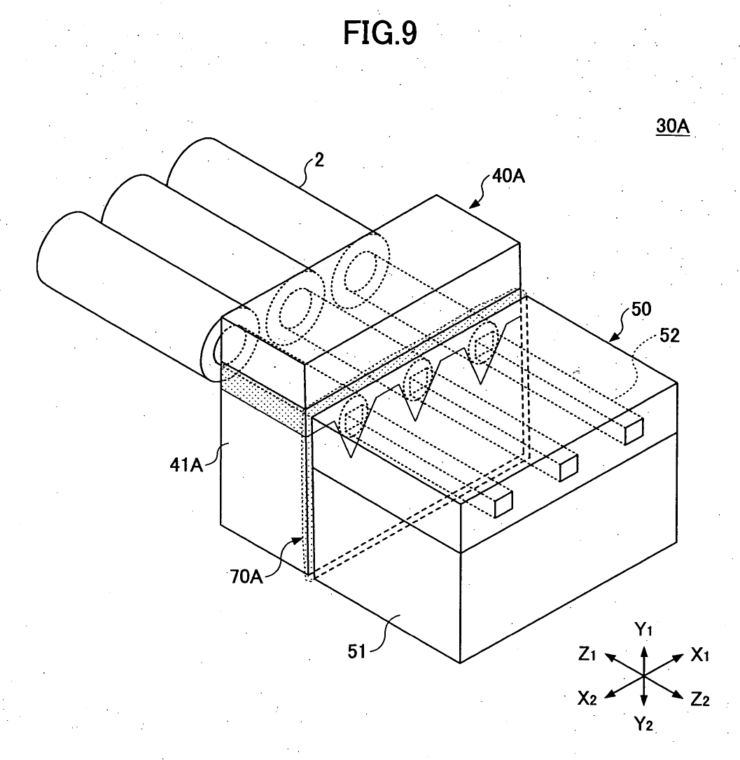

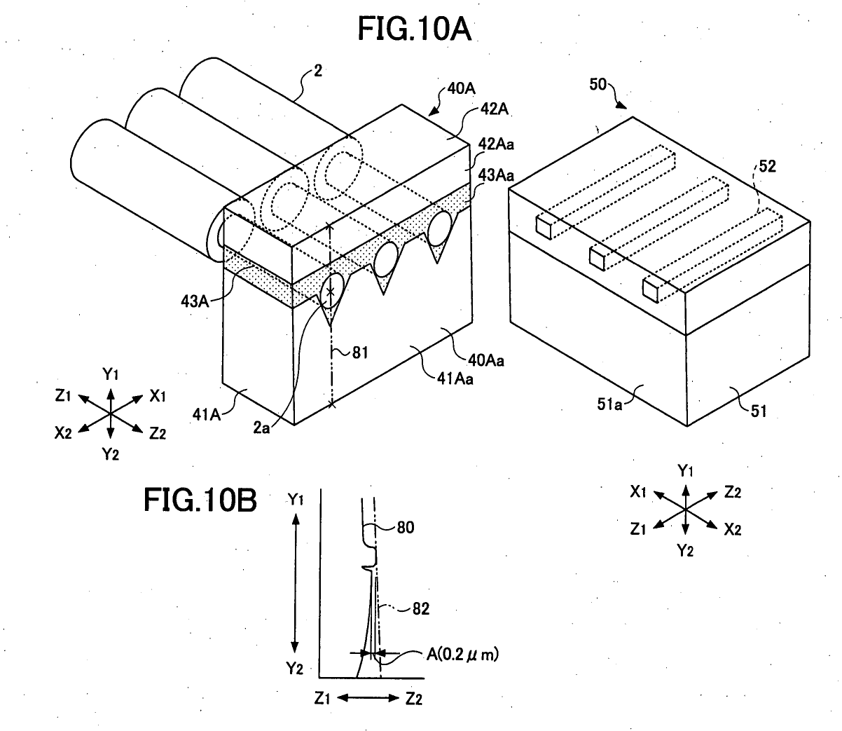

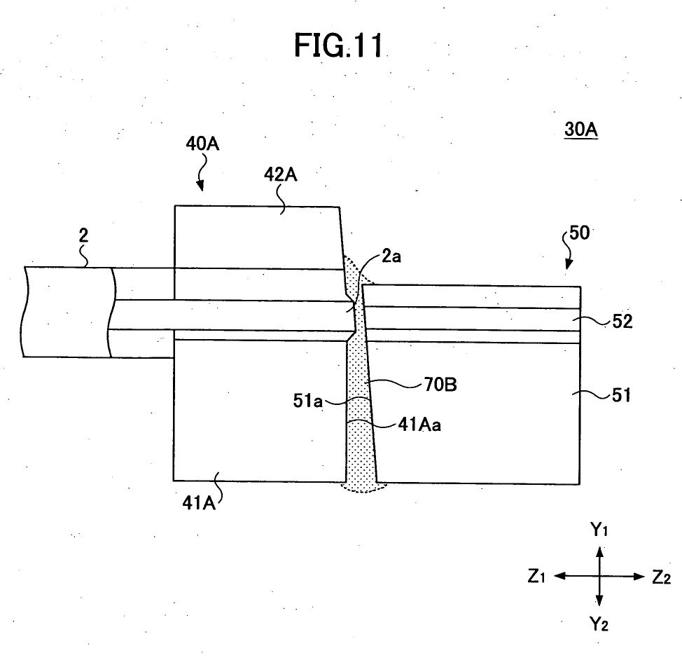

FIGS. 9 through 11 illustrate an optical waveguide module 30A according to a second embodiment of the present invention. FIG. 9 is a perspective view of the optical waveguide-module 30A; FIG. 11 is a cross-sectional elevation view of the optical waveguide module 30A; and FIGS. 10A and 10B show-respectively show a connecting portion between an-optical waveguide element and a band-shaped optical fiber array, and a surface configuration of the optical fiber array.

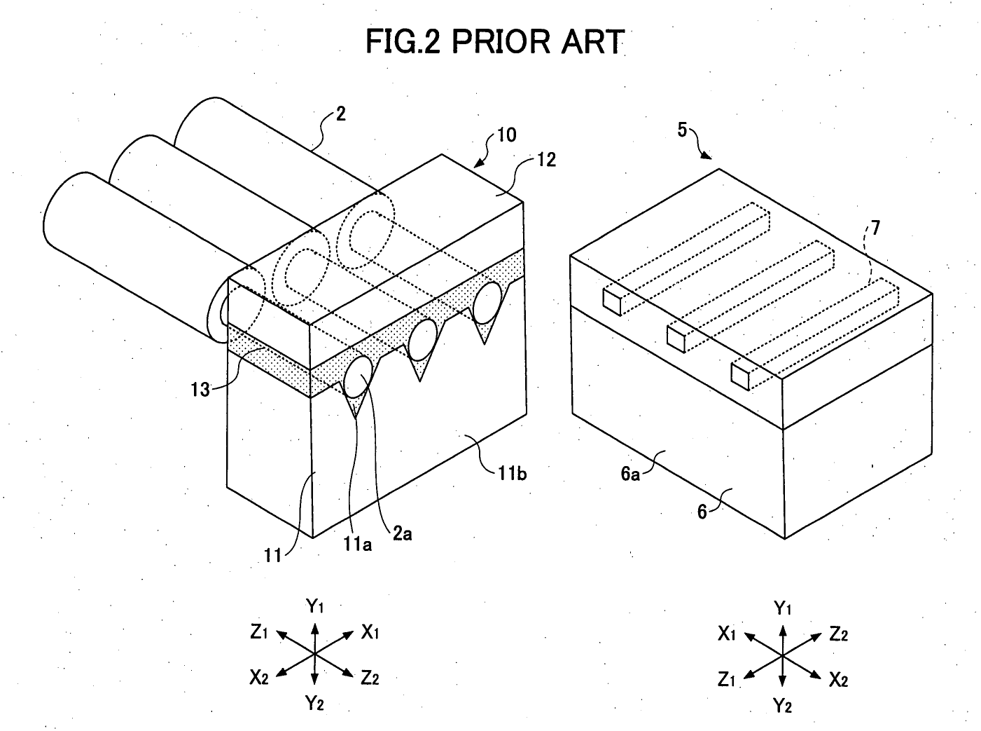

The optical waveguide module 30A of the present embodiment includes an optical fiber array 40A and a high polymer optical waveguide element 50. The optical fiber array 40A has an end surface 40Aa on a side at which the ends of core wires 2a of optical fibers 2 are exposed. The end surface 40Aa includes an end surface 41Aa of a base member 41A, an end surface 42Aa of a cover 42A, end surfaces of the core wires 2a, and an end surface 43Aa of a bonding layer 43A. The end surface 40Aa has a surface configuration as is illustrated by line 80 in FIG. 10B. The line 80 in FIG. 10B represents a relative measurement result obtained by tracing the end surface 40Aa of the optical fiber array 40A in the direction from Y1 to Y2 along line 81 shown in FIG. 10A using a needle point of a surface roughness measurement apparatus. It is noted that line 82 in FIG. 10B represents the surface configuration of the conventional optical fiber array shown in FIG. 2.

According to the present embodiment, the end surfaces of the core wires 2a of the end surface 40Aa are arranged to protrude the farthest. The end surface 41Aa of the base member 41A and the end surface 42Aa of the. cover 42A correspond to slightly tilting surfaces that tilt from the core wire side in the Z1 direction at a rate of −0.1˜−0.2 μm/mm with respect to the position of the end surfaces of the core wires 2a. The end surfaces of the core wires 2a protrude by dimension A (e.g., approximately 0.2 μm) in the Z2 direction with respect to the portions of the end surface 41Ab positioned around the core wires 2a.

The end surface 40Aa (41Aa and 42Aa) may be formed by controlling the load that is impinged on the optical fiber array 40A upon conducting a polishing process, and the fixing method of the optical fiber array.

The optical fiber array 40A and the high polymer optical waveguide element 50 are connected by an adhesive part 70A. Specifically, the core wires 2a and the optical waveguides 52 are aligned, and in this state, the end surface 41Aa of the base member 41A and an end surface 51 of a substrate 51 of the high polymer optical waveguide element 50 are connected by-the adhesive part 70A.

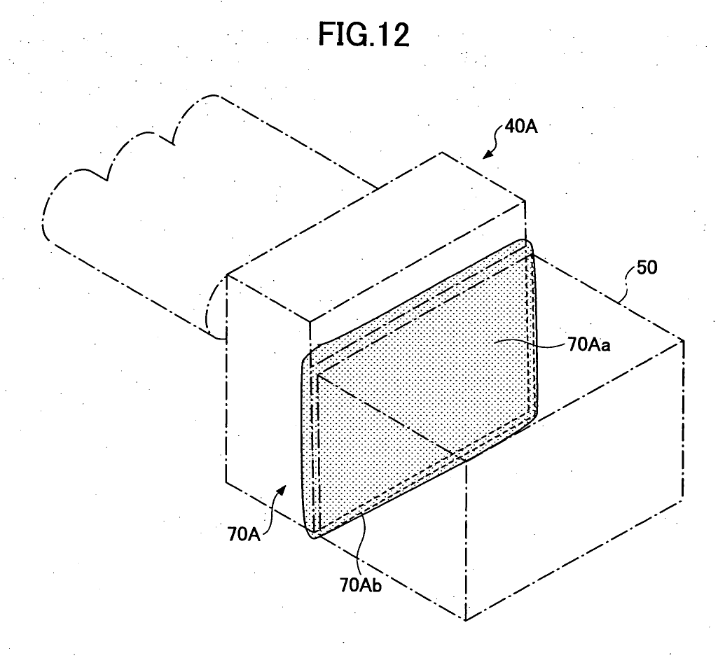

In the present embodiment, the end surface 41Aa corresponds to a tilting surface that tilts from the core wire side in the Z1 direction with respect to the position of the end surface of the core wires 2a, and thereby, a narrow space may be formed between the end surfaces 41Aa and 51a. In turn, the adhesive part 70A may be arranged to have a configuration as is shown in FIG. 12, for example. In this drawing, the adhesive part 70A includes a layer portion 70Aa that extends across the connecting portion between the end surfaces 41Aa and 51a, and a fillet 70Ab that evenly surrounds the periphery of the end surfaces 41Aa and 51a.

In the present embodiment, the layer portion 70Aa extends across the connecting portion between the end surfaces 41Aa and 51a, and the fillet 70Ab is formed around the periphery of the end surfaces 41Aa and 51a, and thereby, the optical fiber array 40A and the high polymer optical waveguide element 50 may be bonded with sufficient strength. Also, the fillet 70Ab is evenly formed around the periphery of the end surfaces 41Aa and 51a, and thereby, a contraction force generated by this fillet 70Ab may be generated uniformly throughout the periphery of the end surfaces 41Aa and 51a so that the force may not act in a direction that may cause the optical fiber array 40A and the high polymer optical waveguide element 50 to warp into V shapes, for example, to disrupt the alignment of the core wires 2a of the optical fibers 2 and the optical waveguides 52 of the high polymer optical waveguide element 50. Thereby, the alignment of the optical fiber array 40A and the high polymer optical waveguide element 50 may be maintained.

Also, in the present embodiment, the end surfaces of the core wires 2a and the end surfaces of the optical waveguides are arranged to be closer to each other compared to the conventional art, and thereby, optical losses maybe reduced.

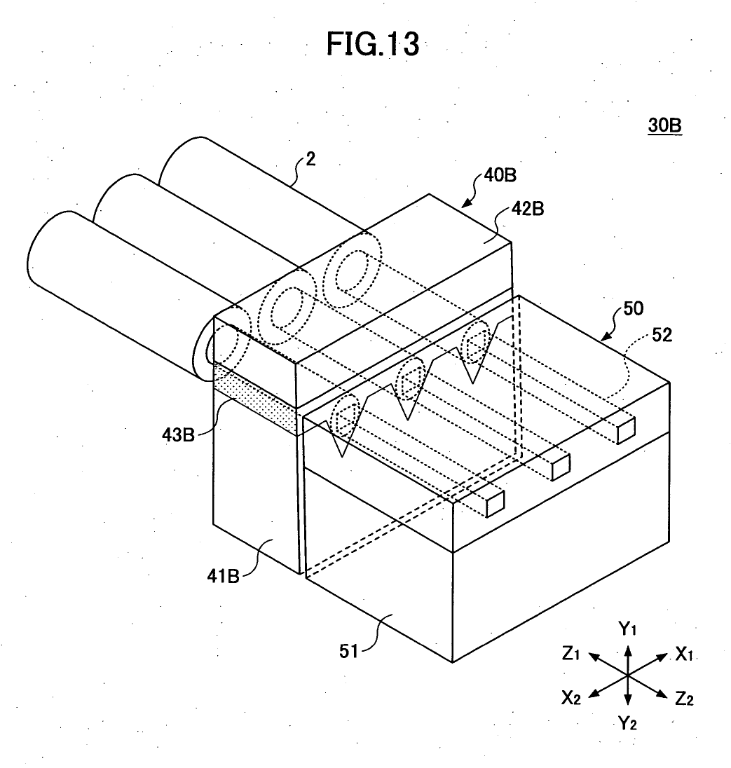

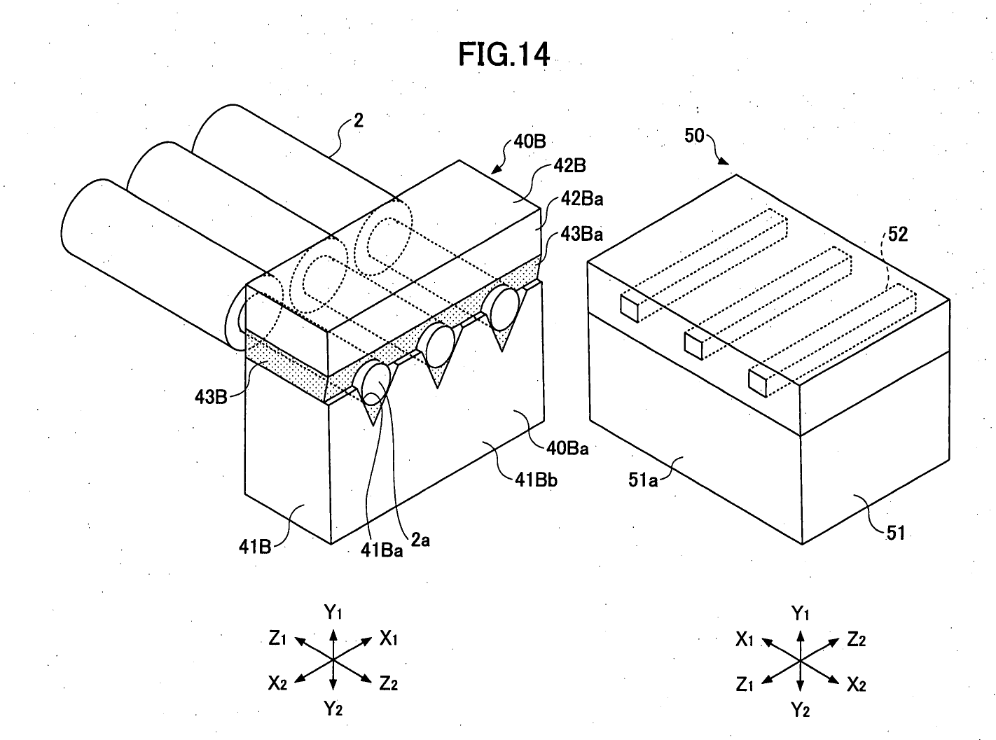

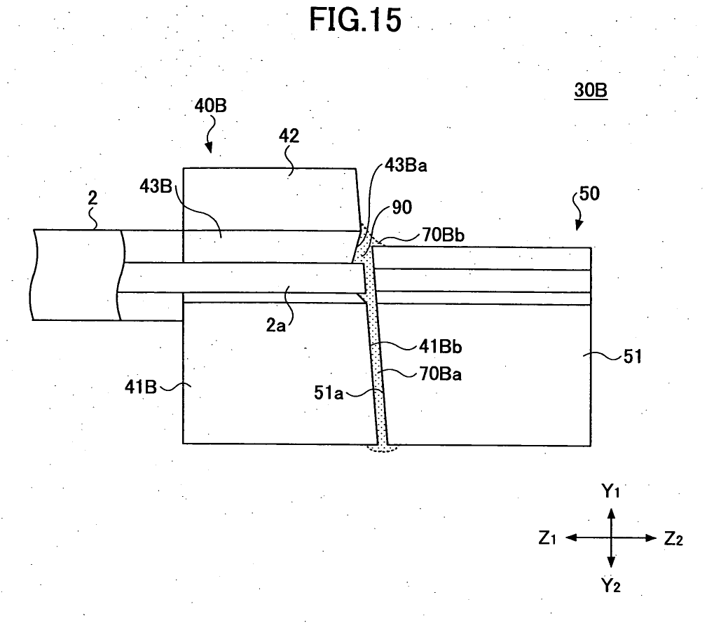

FIGS. 13 through 15 illustrate an optical waveguide module 30B according to a third embodiment of the present invention. FIG. 13 is a perspective view of the optical waveguide module 30B; FIG. 15 is a cross-sectional elevation view of the optical waveguide module 30B; and FIG. 14 shows a connecting portion between an optical waveguide element and a band-shaped optical fiber array.

The optical waveguide module 30B includes an optical fiber array 40B and a high polymer optical waveguide element 50. The optical fiber array 40B includes an end surface 40Ba on a side at which the ends of core wires 2a of optical fibers 2 are exposed. The end surface 40Ba includes an end surface 41Bb of a base member 41B, an end surface 42Ba of a cover 42B, end surfaces of the core wires 2a, and an end surface 43Ba of a bonding layer 43B. The end surfaces 41Bb and 42Ba correspond to flat mirror surfaces. The end surface 40Ba differs from that of the conventional optical waveguide module of FIG. 2 in that the end surface 43Ba of the bonding layer 43B is arranged to recede from the end surfaces of the core wires 2a. For example, the end surface 43Ba of the bonding layer 43B may recede by 0.1 0˜0.3 μm in the Z1 direction with respect to the position of the end 'surfaces of the core wires 2a.

In the present embodiment, the end surfaces 41Bb and 42Ba correspond to flat mirror surfaces. The state in which the end surface 43Ba of the bonding layer 43B is recessed from the end surfaces of the core wires 2a may be realized by arranging the polishing rate for the bonding layer 43B to be higher than that for the base member 41B, the cover 42B, and the core wires 2a so that the bonding layer may be excessively polished. In other words, special processing may not have to be conducted to form the recessed state of the end surface 43Ba.

The optical fiber array 40B and the high polymer optical waveguide module 50 are connected by an adhesive part 70B. Specifically, the core wires 2a and the optical waveguides 52 are aligned, and in this state, the end surface 41Bb of the base member 41B and the end surface 51a of the substrate 51 of the optical waveguide module 50 are connected by the adhesive part 70B.

When the optical fiber array 40B: and the high polymer optical waveguide module 50 are arranged to face each other to align the core wires 2a and the optical waveguides 52, a narrow space 90 may be formed between the end surface 43Ba of the bonding layer 43B and the end surface 51a of the substrate 51. Further, this space may be opened to the exterior at the Y1 side, the X1 side, and the X2 side.

The space may be able to hold the adhesive in place, and thereby, position fixing of the adhesive may be realized by the space 90.

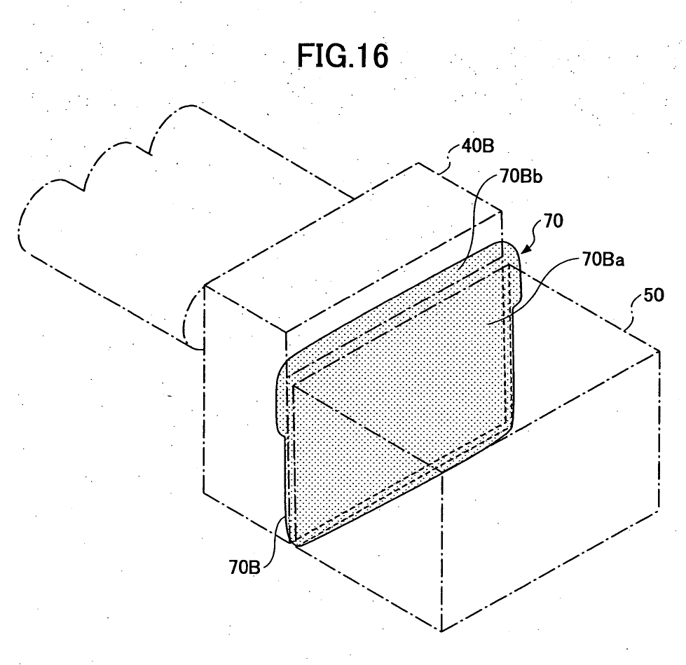

The adhesive part 70B may be arranged to have a configuration as is shown in FIG. 16, for example. In this drawing, the adhesive part 70B includes a layer portion 70Ba that extends across the area between the end surfaces 41Bb and 51a, and a fillet 70Bb of which a large portion sticks out along the upper side of the periphery of the end surfaces 41Bb and 51a, that is, around the end surface 43Ba of the bonding layer 43B.

According to the present embodiment, the optical fiber array 40B and the high polymer optical waveguide module 50 may be bonded with sufficient strength, and the alignment of the optical fiber array 40B and the high polymer optical waveguide module 50 may be maintained.

It is noted that the roughened end surface configuration according to the first embodiment, the protruding configuration of the end surfaces of the core wires according to the second embodiment, and the recessed configuration of the end surface of the bonding layer according to the third embodiment may be combined as necessary or desired.

Further, the present invention is not limited to these embodiments, and variations and modifications may be made without departing from the scope of the present invention.

The present application is based on Japanese Patent Application No. 2003-397469 filed on Nov. 27, 2003, the entire contents of which are hereby incorporated by reference.

1. An optical waveguide module comprising:
an optical waveguide element having a roughened end surface at which end portions of optical waveguides are exposed;
an optical fiber array having a roughened end surface at which end portions of a plurality of core wires of optical fibers are exposed; and
an adhesive part for bonding the optical waveguide element and the optical fiber array, said adhesive part being arranged between the roughened end surface of the optical waveguide element and the roughened end surface of the optical fiber array.

2. The optical waveguide module as claimed in claim 1, wherein the roughened end surface of the optical waveguide element and the roughened end surface of the optical fiber array have an average roughness of at least 0.1 μm.

3. An optical waveguide module, comprising:
an optical waveguide element having an end surface at which end portions of optical waveguides are exposed;
an optical fiber array having an end surface from which end portions of a plurality of core wires of optical fibers protrude; and
an adhesive part for bonding the optical waveguide element and the optical fiber array, said adhesive part being arranged between the end surface of the optical waveguide element and the end surface of the optical fiber array.

4. The optical waveguide module as claimed in claim 3, wherein the end surface of the optical fiber array includes a base member end surface and a cover member end surface that correspond to tilting surfaces that tilt from a core wire side in an opposite direction with respect to the protruding direction of the core wire end portions.

5. An optical waveguide module, comprising:
an optical waveguide element having an end surface at which end portions of optical waveguides are exposed;
an optical fiber array having an end surface at which end portions of a plurality of core wires of optical fibers are exposed, said end surface of the optical fiber array including an end surface of a bonding layer bonding the core wires, which bonding layer end surface is arranged to be recessed with respect to the end portions of the core wires; and
an adhesive part for bonding the optical waveguide element and the optical fiber array, said adhesive part being arranged between the end surface of the optical waveguide element and the end surface of the optical fiber array.
